(19) United States
(12) Patent Application Publication
(10) Pub. No.: US 2015/0106155 A1
(43) Pub. Date: Apr. 16, 2015

(54) Determining and Visualizing Social Media Expressed Sentiment

(71) Applicants: Maria Guadalupe Castellanos, Sunnyvale, CA (US); Perla Ruiz, Hermosillo (MX); Mohamed Dekhil, Santa Clara, CA (US); Meichun Hsu, Los Altos Hills, CA (US); Riddhiman Ghosh, Sunnyvale, CA (US)

(72) Inventors: Maria Guadalupe Castellanos, Sunnyvale, CA (US); Perla Ruiz, Hermosillo (MX); Mohamed Dekhil, Santa Clara, CA (US); Meichun Hsu, Los Altos Hills, CA (US); Riddhiman Ghosh, Sunnyvale, CA (US)

(21) Appl. No.: 14/003,163

(22) PCT Filed: Jun. 8, 2011
(86) PCT No.: PCT/US2011/039566

§ 371 Date: Dec. 19, 2014

(51) Int. Cl. G06Q 30/02; G06Q 50/00

(52) U.S. Cl. CPC G06Q 30/0201; G06Q 50/01
USPC 705/7.29

(57) ABSTRACT

A technique includes determining social media expressed sentiment, including processing data indicative of a plurality of social media messages to decompose each of the social media messages into a plurality of attributes; for each social media message, identifying attributes of the plurality of attributes, which are associated with user selected attribute categories and are part of the message, and for each identified attribute, assigning a sentiment to the attribute and updating statistics for the selected attribute categories based on the assigned sentiment. The technique includes visualizing the social media expressed sentiment, including displaying at least some of the statistics.

### BACKGROUND

The rapid proliferation of online social media sites, such as Twitter® and Facebook®, has made it possible for people to publish their opinions more frequently than ever before. The ease with which people may express their thoughts and make these thoughts instantaneously available on the social media websites is a key reason behind this phenomenon. For many businesses, for purposes of remaining competitive, online opinions represent an invaluable source of information. Therefore, it is not uncommon for a business to have a team of people dedicated to the task of reading what is posted on the various social media web sites and extracting insight into what is being said about the products and services that are offered by the business as well as the products and services that are offered by the competitors.

### BRIEF DESCRIPTION OF THE DRAWING

FIG. 1 is a schematic diagram of a computer system connected to social media web sites via a computer network according to an example implementation.

FIGS. 2, 6A and 6B depict flow diagrams to determine and monitor sentiments associated with online social media messages according to example implementations.

FIG. 3 is an illustration of an architecture to determine and monitor sentiments associated with online social media messages according to an example implementation.

FIG. 4 is an illustration of a graphical user interface to monitor sentiments associated with online social media messages according to an example implementation.

FIG. 5 is an illustration of a graphical user interface to control parameters associated with sentiment monitoring according to an example implementation.

### DETAILED DESCRIPTION

In accordance with exemplary implementations, systems and techniques are disclosed herein for purposes of monitoring online social messages (Twitter® and Facebook® microblogs, as non-limiting examples) to gain insight about the sentiments that are expressed in these messages. More particularly, the systems and techniques that are disclosed herein assign sentiments to the attributes of each monitored message, as compared to assigning a sentiment to each message as a whole.

The assignment of sentiments to message attributes allows better insight to be gleaned from the monitored messages. For example, a user (an employee of Company MNO or a person otherwise hired by Company MNO, as non-limiting examples) may desire to monitor sentiments of Twitter® messages (or “tweets”) that contain the keyword phrases “Company MNO printer” and “ink.” A particular tweet that conforms to this search criteria may specify, “I love my new company MNO printer but the ink runs out too fast”. Assigning this exemplary tweet an overall neutral score is not as informative as decomposing the tweet into its attributes and assigning a sentiment to each attribute. Assuming that the attributes of this exemplary tweet are “company MNO” and “ink,” the “Company MNO printer” attribute of the tweet, may be assigned a positive sentiment, while the “ink” attribute may be assigned a negative sentiment. Thus, for this example, the overall sentiment for the message may have traditionally been indicated as being neutral, whereas the decomposition of the message into its attributes and the assignment of sentiment values to these attributes allows the user monitoring the tweets to gain a better understanding regarding what is being said in the online social media about Company MNO's products and services.

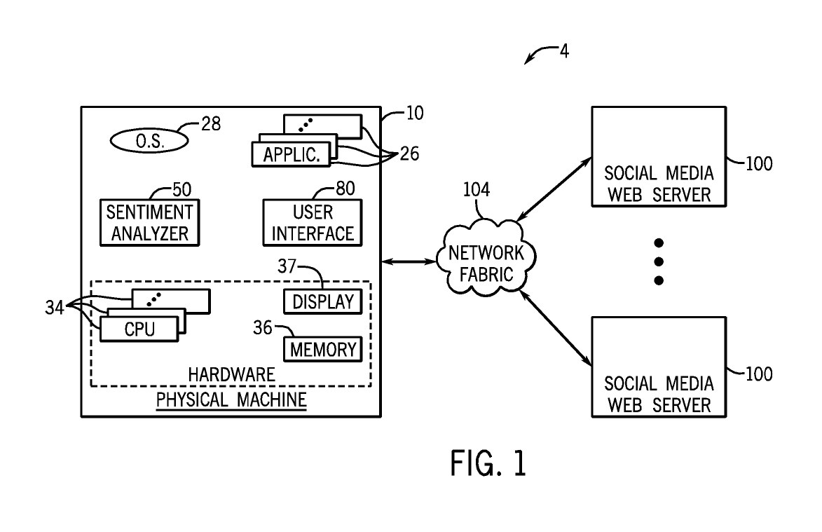

Referring to FIG. 1, as a non-limiting example, the systems and techniques that are disclosed herein may be implemented in a computer system 4, which includes one or multiple physical machines 10. In this context, a “physical machine” indicates that the machine is an actual machine made of executable program instructions and hardware. Examples of physical machines include computers (e.g., application servers, storage servers, web servers, etc.), communications modules (e.g., switches, routers, etc.) and other types of machines. The physical machine 10 may be located within one cabinet (or rack); or alternatively, the physical machine(s) may be located in multiple cabinets (or racks).

As depicted in FIG. 1, the physical machine 10 is connected through a network fabric 104 to various other computers, such as online and Internet-based social media web servers 100. The network fabric 104 may include, for example, a local area network (LAN), a wide area network (WAN), the Internet, or any other type of communications link. The network fabric 104 may also include system busses or other fast interconnects.

In accordance with a specific example described herein, the physical machine 10 contains machine executable program instructions and hardware that executes these instructions for purposes of monitoring sentiments associated with social media messages that are posted on the various social media web servers 100. In this manner, the execution of the machine executable instructions allows a user on the physical machine 10 to visualize (via a user interface 80) real time or near real time sentiments associated with attributes of these social media messages that are targeted by the user's keyword search. Although the machine executable instructions and hardware are discussed herein as being part of a single physical machine 10, the computer system 4 may include one or multiple additional physical machines 10 for purposes of performing the online sentiment monitoring and visualization, in accordance with other example implementations.

It is noted that the architecture that is depicted in FIG. 1 may be implemented in an application server, a storage server farm (or storage area network), a web server farm, a switch or router farm, other type of center, and so forth. Additionally, although the physical machine 10 is depicted in FIG. 1 as being contained within a box, the physical machine 10 may be a distributed machine having multiple nodes, which provide a distributed and parallel processing system, in accordance with other example implementations.

As depicted in FIG. 1, in accordance with some example implementations, the machine executable instructions of the physical machine 10 include one or multiple applications 26, and an operating system 20 and other instructions, such as one or multiple device drivers, which may be part of the operating system 28. In general, the machine executable instructions are stored in storage, such as in a memory 36 of the physical machine 10. In general, the machine executable instructions may be stored in a non-transitory medium or non-transitory media, such as in system memory, in a semiconductor memory, a removable storage media, an optical storage, a magnetic storage, non-removable storage media, in storage separate (local or remote) from the physical machine 10, etc., depending on the particular implementation.

The hardware 32 of the physical machine 10 includes one or multiple processors that execute the machine executable instructions, such as one or multiple central processing units (CPUs) 34 or one or multiple processing cores of one or more multiple CPU(s) 34.

In accordance with some example implementations, the processor(s) of the physical machine 10 execute a set of machine executable instructions to form a processor-based “sentiment analyzer 50” to allow a user to define search criteria for targeting certain online social media messages and various parameters (described below) pertaining to visualization of the monitored sentiments associated with these messages; acquire recently posted online social media messages subject to the user-specified search criteria; decompose these messages to identify attributes in each message; assign sentiment values to each of the attributes; determine statistics characterizing the attribute sentiments; and generate data, which may be displayed on the physical machine's display 37 for purposes of allowing the user to, in real time or near real time, visualize the sentiments.

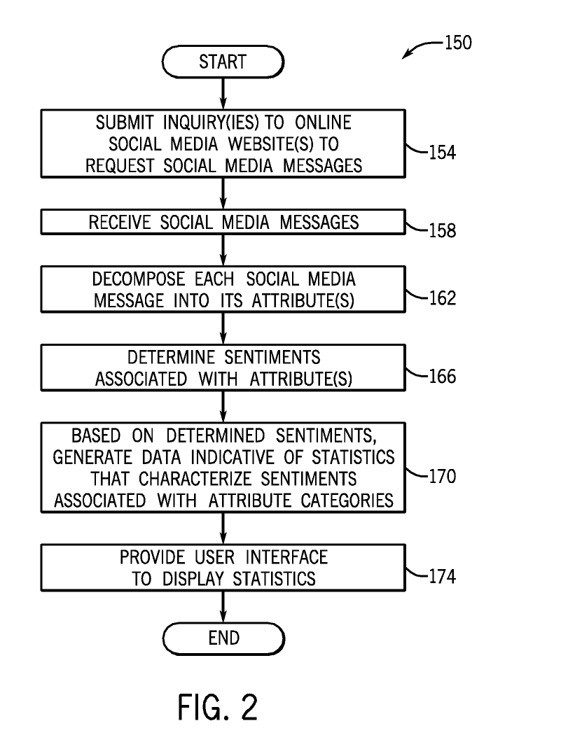

More specifically, referring to FIG. 2 in conjunction with FIG. 1, in accordance with example implementations, the sentiment analyzer 50 perform a technique 150, which includes submitting (block 154) one or multiple inquiries to online social media website(s) to request social media messages and receiving (block 158) the social media messages. The technique 150 includes decomposing (block 162) each social media message into one or multiple attribute(s). The sentiment analyzer 50 also determines (block 166) sentiments associated with the attributes of the messages and based on the determined sentiments, generates (block 170) data indicative of statistics that characterize the sentiments associated with the attribute categories. Finally, the sentiment analyzer 50 provides (block 174) a user interface to display the statistics and in general, control visualization parameters and other criteria related to the sentiment monitoring (further described below).

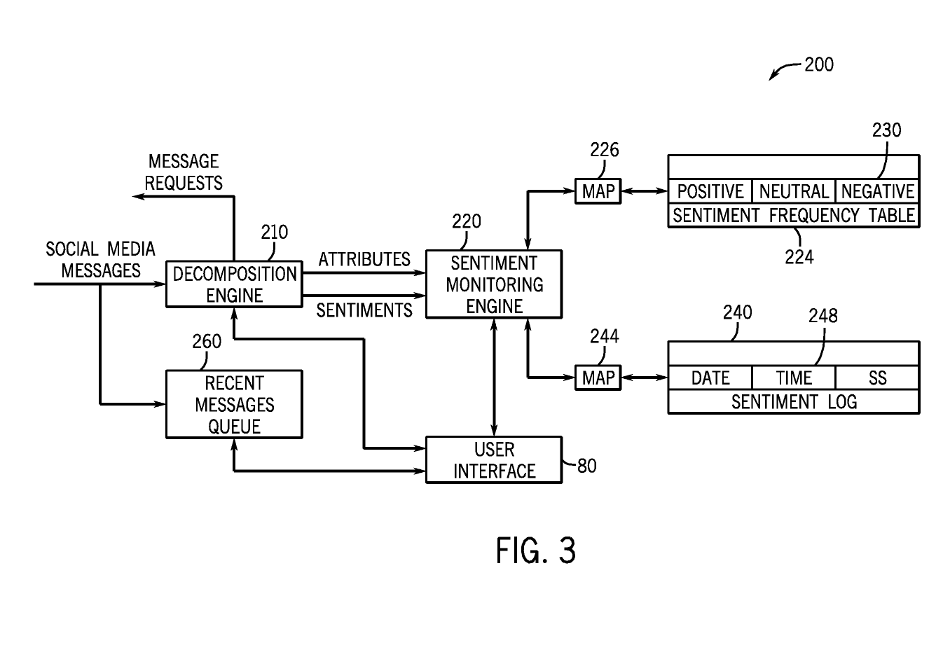

Referring to FIG. 3, in accordance with some example implementations, the sentiment analyzer 50 has a general architecture 200, which includes a decomposition engine 210 for purposes of requesting messages from online social media websites based on selected user criteria, identifying the attributes of these messages and assigning sentiments to the attributes. For purposes of guiding this search and the corresponding requests that are made by the decomposition engine 210, the user may specify keywords, which are provided to the social media websites for purposes of acquiring all messages with those keywords. Thus, the decomposition engine 210 receives targeted messages from the social media websites.

The decomposition engine 210 may identify attributes in the received messages one of a number of different ways, depending on the particular implementation. As a non-limiting example, in accordance with some example implementations, the user defines a list of attributes, and the decomposition engine 210 scans through the language of each received message for purposes of identifying attributes contained in the messages based on this list. It is noted that the list may contain keywords that are used in the search as well as words other than the search keywords. When the decomposition engine 210 identifies one of these specified attributes, the decomposition 210 evaluates the sentiment of the attribute and assigns it a corresponding sentiment value.

In other example implementations, the decomposition engine 210 analyzes the content of each social media message to identify attributes based on criteria other than a user-specified list. For example, the decomposition engine 210 may analyze each message based on its sentence structure and corresponding part of speech to identify nouns in the message such that each of the nouns is deemed to be an attribute. Other variations are contemplated for purposes of identifying attributes in accordance with other example implementations.

The decomposition engine 210 may also examine the sentence structure and parts of speech of a given message for purposes of assigning a sentiment value for each identified attribute of the message. For example, the decomposition engine 210 may examines modifiers (i.e., adjectives or adverbs) that modify a given attribute in the message for purposes of determining a sentiment value for that attribute. As a non-limiting example, the decomposition engine 210 may compare the executed modifiers to lists of modifiers that are predesignated as being associated with negative, neutral and positive sentiments. Regardless of the partitioning used to assign the sentiment, in accordance with some example implementations, the decomposition engine 210 assigns one of three sentiment values to a given attribute:: a “−1” identifying a negative sentiment; a “0” identifying a neutral sentiment; and a “+1” identifying a positive sentiment.

The sentiment monitoring engine 220 communicates with the decomposition engine 210 to retrieve the attributes; retrieve the sentiment values for the attributes; and organize and store the data in various data structures as follows. First, the sentiment monitoring engine 220 maintains a sentiment frequency table 224, which in general, is indexed (via a map 226) according to attribute categories such that the table 224 indicates the number of negative, neutral and positive sentiments expressed for each attribute category.

Thus, for the example that is set forth above, an attribute category of “ink” may be created such that any time the decomposition engine 210 identifies an “ink” attribute in a message and assigns a sentiment value to the “ink” attribute, the corresponding sentiment frequencies for the attribute category “ink” is updated. As depicted in FIG. 3, an exemplary entry 230 is indexed to a given attribute category and contains fields for the positive, neutral and negative sentiment frequencies for that attribute category. Thus, as a non-limiting example, an entry 230 for the “ink” category may at a particular time show 3 negative sentiments, 4 neutral sentiments and 15 positive sentiments.

The sentiment monitoring engine 220 also maintains a sentiment log 240, which tracks the overall sentiment score for each monitored social media message. In this manner, the entries in the log 240 are indexed (via a map 244) to an attribute category. Therefore, each attribute category may index one or multiple social media messages that are tracked in the sentiment log 240. As a non-limiting example, exemplary entry 248 contains fields that identify the data and time of an associated message, along with a field that identifies an overall sentiment score for that message. A given attribute category may point to several such entries 248.

In accordance with an example implementation, the sentiment monitoring engine 220 monitors a user-specified time window of the targeted social media messages, such that, in general, as new messages arrive, a corresponding number of messages is discarded from the window.

As also depicted in FIG. 3, the architecture 200 includes a user interface 80 for purposes of allowing a user to visualize in real time or near real time the sentiments associated with online social media messages that are targeted by the user's search criteria. Depending on the particular implementation, the user interface 80 may allow the user to monitor one or more of the following. First, the user interface 80 may allow the user to visualize the most frequently occurring attribute categories in the social media messages targeted by the keyword search by the user. Therefore, the user may, in an iterative process, refine which attribute categories are specifically monitored in real time or near real time, based on this visualization. As a non-limiting example, in an exemplary implementation, the user interface 80 may generate a tag cloud that appears on the user's display for purposes of illustrating the ten most frequently occurring attribute categories in the messages that are targeted by the user's specified search criteria for a specified period of time. For this example, the font sizes of each displayed attribute category may be sized accordingly such that the more frequently occurring attribute categories have larger font sizes than the font sizes of the attribute categories that occur less frequently. The user interface 80 sets the colors of the displayed attribute categories in this tag cloud according to the average sentiment associate with the categories. For example, if the average sentiment for one of the displayed attribute categories is negative, the user interface 80 may display the attribute in a red color that is associated with a negative sentiment. Attribute categories that are associated with positive sentiments may be displayed in green colors. Continuing the example, attribute categories that are associated with neutral sentiments may be displayed using black colors. It is noted that other techniques, other than tag clouds and other than the specific tag cloud disclosed herein, may be used for displaying and visualizing the most frequently occurring attribute categories, in accordance with other example implementations.

In addition to the above-described visualization of the most frequently occurring attribute categories, the user interface 80 may display one or multiple real time charts, illustrating the real time or near real time sentiments associated with various attribute categories. Additionally, in accordance with some example implementations, the user interface 80 also displays more recently received social media messages (the last five or ten received media messages, for example), which are stored in a recent messages queue 260.

Among the other features of the architecture 200, the user interface 80 allows the user to configure the various parameters that are used to target certain social media messages for monitoring. As a non-exhaustive list, the user interface 80 permits the user to customize what is viewed in the user interface 80, control the keywords associated with the online social media message search, control the selection of the attribute categories that are monitored in real time, control which online media websites are searched for purposes of retrieving the online social media messages, control an aggregation period for averaging sentiment scores, and determine various other parameters associated with the visualization of the monitored sentiments, as further described below.

Additionally, in accordance with exemplary implementations, the user interface 80 allows the user to select a time window on the input stream of incoming social media messages. In this regard, the selectable time window specifies how many social media messages are monitored and analyzed at one time. As the social media messages are received in a streaming fashion, each newly-received social media messages causes the oldest social media message in the time window and its corresponding statistics to be discarded.

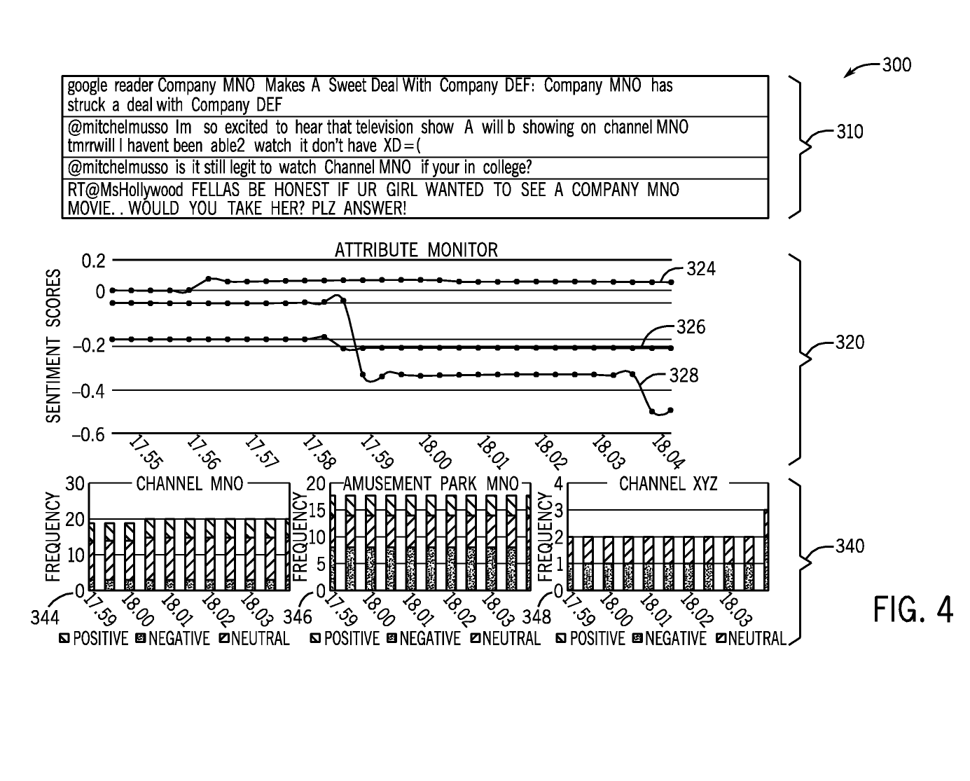

The user interface 80 generates a graphical user interface (GUI) 300 (see FIG. 4), in accordance with some embodiments of the invention. The GUI 300, in general, contains three sections 310, 320 and 340. The section 310 displays the most recently-received social media messages (which may be significantly less than the number of messages that are within the above-described time window, for example). In accordance with some implementations, the GUI 300 includes “play” and “pause” buttons (not depicted in FIG. 4) for purposes of allowing a user to pause and resume the updating of messages in the section 310, depending on how fast the messages 310 are being updated in the section 310. In other implementations, the user may specify or throttle the update rate for the messages in the section 310.

In section 320, the GUI 300 displays the overall sentiment score for attribute categories that are specified by the user. For example, the user may specify that the sentiment analyzer 50 is to track attribute categories associated with “Channel DEF,” “Amusement Park ABC,” and “Channel XYZ.” As depicted in FIG. 4, the GUI 300 displays corresponding sentiment scores versus time waveforms 324, 326 and 328, which for this non-limiting example, are associated with the Channel DEF, Amusement Park ABC and Channel XYZ attribute categories, respectively. This permits the user to monitor the sentiment scores for the specified attribute categories in real or near real time. Section 340 of the GUI 300 allows the user to monitor sentiment frequencies for the attribute categories monitored in section 320 in real time. As shown for this example, the frequencies for Channel DEF, Amusement Park ABC and Channel XYZ are monitored in corresponding panels 344, 346 and 348 of the section 340. It is noted that each of the panels 344, 346 and 348 scroll from right to left as each update is made, in accordance with an example implementation. Moreover, the scales of the panels 344, 346 and 348 may vary according to the magnitudes of the frequencies being displayed. For example, the panel 346 has a vertical scale of zero to 20, whereas the panel 348 has a vertical scale of zero to 4.

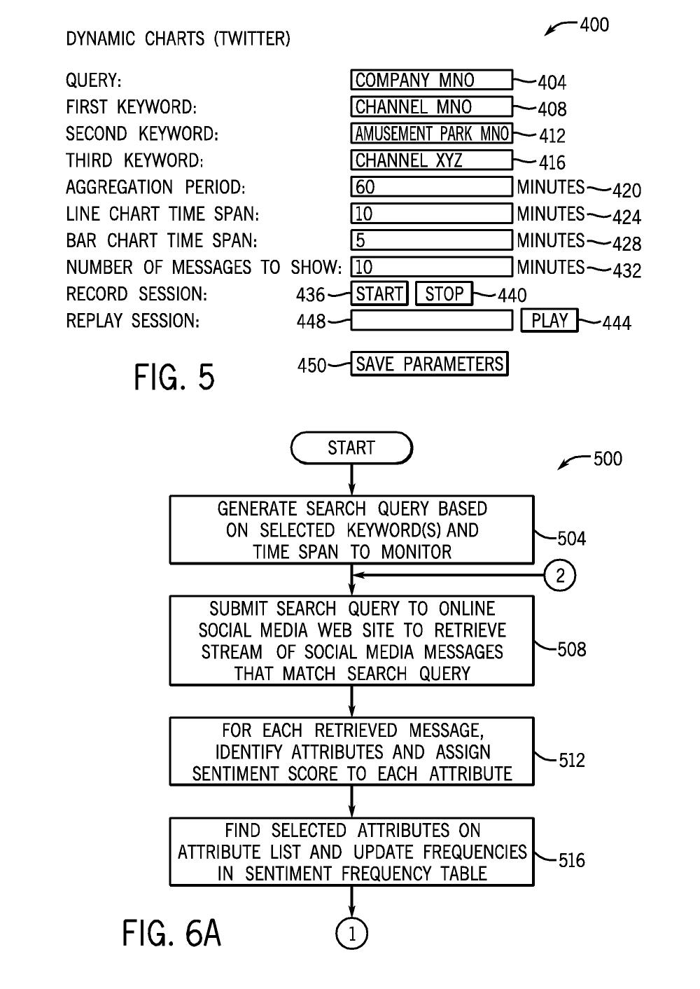

FIG. 5 depicts a GUI 400, which may be generated by the user interface 80 for purposes of selecting certain parameters that control the targeting of the online social media messages, in accordance with an example implementation. The GUI 400 includes a query field 404, which for this example allows entry of the keywords for searching the social media websites for purposes of retrieving targeted social media messages. Fields 408, 412 and 416 allows the entry of attribute categories in these targeted social media messages, which the user desires to monitor. Field 420 allows entry of an aggregation period (in minutes, for example), or the period in which the most recently sentiment scores are averaged for purposes of generating the sentiment scores and sentiment frequencies in sections 320 and 340 of the GUI 300 (see FIG. 4). The GUI 400 also includes fields 424 and 428, which allows entry of line chart and bar chart time spans; and the GUI 400 includes a field 432 to allow the entry of the number of social messages to show in the section 310 (see FIG. 4).

Moreover, in accordance with some example implementations, the GUI 400 includes a start button 436 and a stop button 440 for purposes of controlling the recording of the current monitoring session. Previous sessions may be replayed by the user entering the appropriate file name in a field 448 and clicking on a play button 444 of the GUI 400, in accordance with some example implementations. As also shown in FIG. 5, the parameters entered as part of the GUI 400 may be saved via a save parameter button 450, in accordance with example implementations.

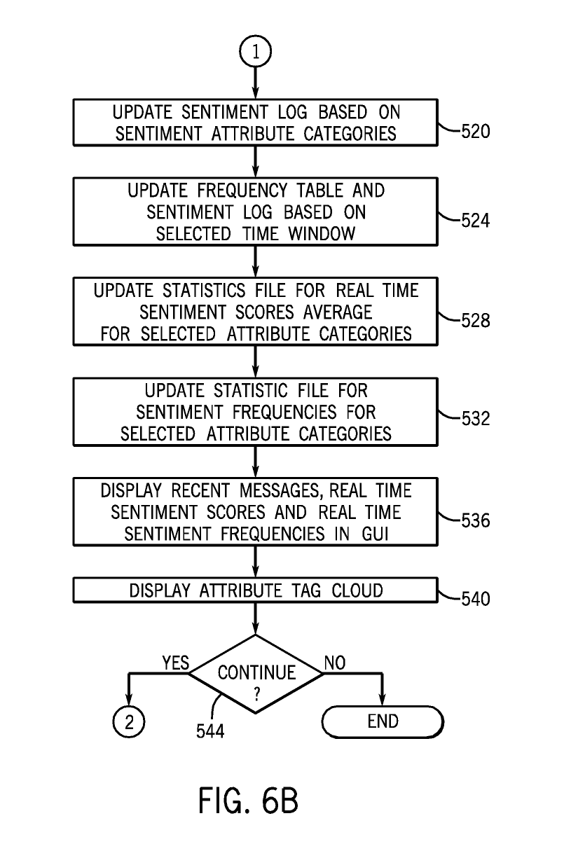

Referring to FIG. 6A in conjunction with FIG. 1, in accordance with some example implementations, the sentiment analyzer 50 performs a technique 500 for purposes of monitoring sentiments associated with online social media messages. Pursuant to the technique 500, the sentiment analyzer 50 generates (block 504) a search query based on one or multiple user selected keywords and a selected time span to monitor. Next, the sentiment analyzer 50 submits the search query to an online social media website to retrieve a stream of social media messages that match the search query, pursuant to block 508. For each retrieved message, the sentiment analyzer 50 identifies (block 512) one or multiple attributes of the message and assigns a sentiment score to each attribute. Next, the sentiment analyzer 50 finds (block 516) selected attributes on the acquired attribute list and updates frequencies in the sentiment frequency table.

Referring to FIG. 6B in conjunction with FIG. 1, the sentiment analyzer 50 next updates (block 520) the sentiment log based on the selected attribute categories and updates (block 524) the frequency table and sentiment log based on the selected time window. The sentiment analyzer 50 then updates (block 528) the statistics file for real time sentiment score averages for the selected attribute categories and updates (block 532) the statistics file for sentiment frequencies for the selected attribute categories. The sentiment analyzer 50 then displays (block 536) recent messages, real time sentiment scores and real time sentiment frequencies in the GUI, pursuant to block 536. Moreover, depending on the particular implementation, the sentiment analyzer 50 may display an attribute tag cloud showing the most frequently appearing attribute categories within a selected period of time, pursuant to block 540.

In accordance with some implementations, the sentiment analyzer 50 may operate on a single uninterrupted thread and as such, the sentiment analyzer 50 may determine (diamond 544) whether the thread has been interrupted, and if not, control returns to block 508 to continue the real time analysis and monitoring of the online social media sentiment.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
determining social media expressed sentiment, comprising:
processing data indicative of a plurality of social media messages in a machine to decompose each of the social media messages into a plurality of attributes and for each social media message identify attributes of the plurality of attributes which are associated with user selected attribute categories and are part of the message; and
for each identified attribute, assigning a sentiment to the attribute and updating statistics for the selected attribute categories based on the sentiment assigned to the attribute; and
visualizing the social media expressed sentiment, comprising displaying at least some of the statistics.

2. The method of claim 1, wherein the statistics indicate frequencies of different sentiment categories.

3. The method of claim 1, wherein the statistics indicate a mean sentiment for at least one of the attribute categories.

4. The method of claim 1, further comprising:
performing searches on at least one online social media site to produce the data indicative of the social media messages; and
updating the data indicative of the statistics as the data indicative of the social media messages is acquired due to the searches.

5. The method of claim 4, further comprising:
performing the searches based on keywords provided by a user.

6. The method of claim 1, further comprising:
providing an interface to allow a user to select the attribute categories.

7. The method of claim 1, wherein the social media messages are posted at different times, the method further comprising:
providing an interface to allow a user to select the attribute categories; and
displaying a subset of the social media messages on a display associated with the social media messages; and
continually refreshing the displayed subset of the social media messages to corresponding more recently posted social media messages.

8. The method of claim 1, wherein the displaying comprises displaying the statistics in real time or near real time as the social media messages are posted on online web sites.

9. An article comprising at least one machine-readable storage medium storing instructions that upon execution cause a system having at least one processor to perform a method according to any of claims 1-8.

10. A system comprising:
a processor-based decomposition engine to:
receive data indicative of social media messages;
parse each of the social media messages into a plurality of attributes; and
for each social media message, identify attributes of the plurality of attributes which are associated with user selected attribute categories and are part of the message;
a processor-based sentiment monitoring engine to determine social media expressed sentiment, the sentiment monitoring engine adapted to, for each identified attribute, assign a sentiment to the attribute and update statistics for the selected attribute categories based on the sentiment assigned to the attribute; and
a user interface to at least display at least some of the statistics to visualize the social media expressed sentiment.

11. The system of claim 10, wherein the statistics indicate frequencies of different sentiment categories.

12. The system of claim 10, wherein the statistics indicate a mean sentiment for at least one of the attribute categories.

13. The system of claim 10, wherein the social media messages are posted at different times, wherein the user interface is further adapted to:
allow the user to select the attribute categories;
display a subset of the social media messages on a display associated with the social media messages; and
continually refresh the displayed subset of the social media messages to corresponding more recently posted social media messages.

14. The system of claim 10, wherein the sentiment monitoring engine is adapted to determine a set of the attribute categories that appear most frequently in the social media messages and cause the user interface to indicate frequencies at which the attributes associated with the attribute categories of the set appear in the social media messages and the sentiments associated with the attribute categories of the set.

15. The system of claim 10, wherein the sentiment monitoring engine is adapted to cause the user interface to allow the user to select a time window to designate social media messages appearing within the time window for parsing.
